(19) United States
(12) Patent Application Publication
(10) Pub. No.: US 2006/0142448 A1
(43) Pub. Date: Jun. 29, 2006

(54) Brightness enhancement film and a method of manufacturing thereof

(75) Inventors: Jin-Sung Choi, Yongin-si (KR); Jin-Mi Jung, Seoul (KR); Dong-Hoon Kim, Seoul (KR); Jeong-Hwan Lee, Suwon-si (KR); Jheen-Hyeok Park, Seongnam-si (KR)

Correspondence Address: MCGUIREWOODS, LLP, 1750 TYSONS BLVD, SUITE 1800, MCLEAN, VA, 22102, US

(73) Assignee: Samsung Electronics Co., Ltd.

(21) Appl. No.: 11/298,453

(22) Filed: Dec. 12, 2005

(30) Foreign Application Priority Data
Dec. 27, 2004 (KR) 10-2004-0113307

(51) Int. Cl. C08K 5/10

(52) U.S. Cl. 524/315

(57) ABSTRACT

A brightness enhancement film (BEF) is provided, the BEF includes a polymer film having dopants, wherein a concentration of the dopants gradually varies with respect to a depth of the BEF.

### CROSS REFERENCE TO RELATED APPLICATION

This application claims priority to and the benefit of Korean Patent Application No. 10-2004-0113307 filed on Dec. 27, 2004 which is hereby incorporated by reference for all purposes as if fully set forth herein.

### BACKGROUND OF THE INVENTION

1. Field of the Invention

The present invention relates to an improved brightness enhancement film and a method of manufacturing thereof.

2. Description of Related Art

A liquid crystal display (LCD) includes a transistor panel having gate lines, data lines, switching elements such as thin film transistors (TFTs), and pixel electrodes; a color filter panel facing the transistor panel and having color filters and a common electrode; and a liquid crystal (LC) layer interposed therebetween.

The pixel electrodes are connected with the TFTs and are supplied with data voltages through the data lines. The common electrode covers an entire surface of the color filter panel and is supplied with a common voltage. A pair of the pixel electrode and the common electrode generate an electric field in cooperation with each other and a liquid crystal is disposed therebetween to form a liquid crystal capacitor.

The LCD applies voltages to the pixel electrodes and the common electrode to generate the electric field to the LC layer. The strength of the electric field may be controlled by adjusting the voltage across the LC capacitor. Since the electric field determines the orientations of LC molecules and the molecular orientations determine the transmittance of light passing through the LC layer, the light transmittance is adjusted by controlling the applied voltages, thereby obtaining a desired image.

The LCD requires a light source, such as an artificial source or natural light. Since only a small amount of light from the light source enters into the LCD, a lot of light is lost and the brightness of the LCD is low.

To increase the brightness, the LCD may include various optical films such as a brightness enhancement film (BEF).

BEFs are divided into a prism-type BEF and a reflective polarization film.

The reflective polarization film transmits light of a predetermined polarization direction transmit and reflects light of a polarization direction that is substantially perpendicular to the predetermined polarization direction. The reflected light is reflected again by an optical film such as a reflective film of a backlight unit toward the reflective polarization film. At this time, a polarization direction of some of the light reflected toward the reflective polarization film is changed so that it may be transmitted through the reflective polarization film, thereby improving the brightness of the LCD.

However, the reflective polarization film is formed into two layers having different refractive indexes and that are each overlapped multiple times, e.g., hundreds of times or more, which increases manufacturing cost and complicates a manufacturing process.

### SUMMARY OF THE INVENTION

The present invention provides an improved brightness enhancement film and a method of manufacturing thereof.

Additional features of the invention will be set forth in the description which follows, and in part will be apparent from the description, or may be learned by practice of the invention.

The present invention discloses a brightness enhancement film (BEF) including a polymer film comprising dopants, wherein a concentration of the dopants gradually varies with respect to a depth of the BEF.

The present invention also discloses a method of manufacturing a brightness enhancement film (BEF), including forming at least two fixed materials for the BEF which comprise dopants substantially uniformly fixed with a polymer for the BEF and have a different dopant concentration; sequentially laminating the fixed materials; and cooling and drawing the laminated fixed materials.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a sectional view of a brightness enhancement film (BEF) according to an embodiment of the invention.

FIG. 2 is a sectional view representing dopant concentration included in a BEF according to an embodiment of the invention.

FIG. 3 is a sectional view of an LCD using a BEF according to an embodiment of the invention.

FIG. 4 is a graph showing dopant concentration with respect to depth within a BEF according to an embodiment of the invention.

FIG. 5 is a graph showing refractive index differences with respect to depth within a BEF according to an embodiment of the invention.

FIG. 6 is a table comparing characteristics of a BEF according to an embodiment of the invention with characteristics of a conventional BEF.

FIG. 7 is a table showing a type of dopant used in a BEF according to an embodiment of the invention.

FIG. 8 is a flow chart showing a method of manufacturing a BEF according to an embodiment of the invention.

FIG. 9 is a lateral view of a T-die used for manufacturing a BEF according to an embodiment of the invention.

FIG. 10 is a front view of the T-die shown in FIG. 9.

### DESCRIPTION OF THE ILLUSTRATED EMBODIMENTS

The present invention now will be described more fully hereinafter with reference to the accompanying drawings, in which preferred embodiments of the inventions invention are shown. This invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

BEFs and methods of manufacturing a BEF according to embodiments of the present invention are described below with reference to the drawings.

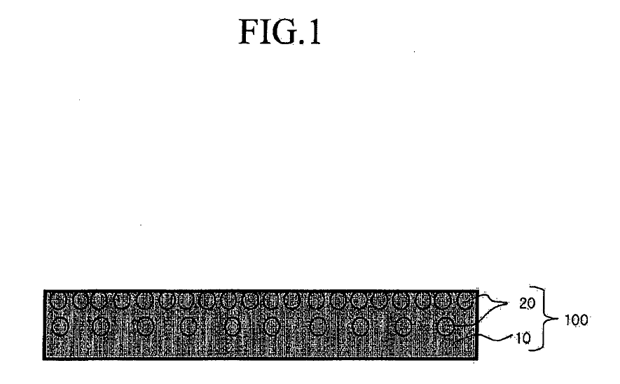

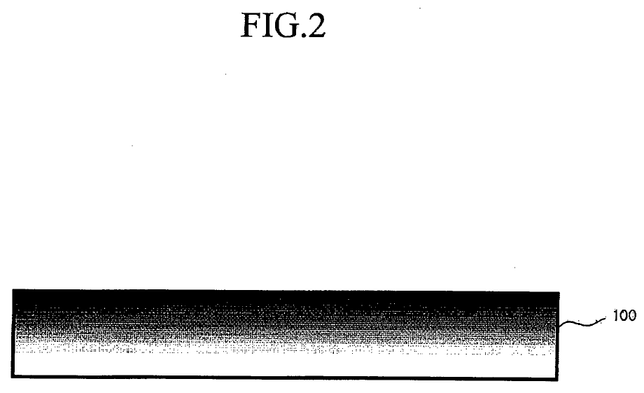

FIG. 1 is a sectional view of a BEF according to an embodiment of the present invention. FIG. 2 is a sectional view representing dopant concentration contained in a BEF according to an embodiment of the present invention.

Referring to FIG. 1, a BEF 100 includes a body 10 and dopants 20 included in the body 10. As shown in FIGS. 1 and 2, dopant concentration of the BEF 100 decreases toward a lower portion thereof. In FIG. 2, as the color density darkens, the dopant concentration increases.

The dopants 20 are not polymerized with the body 10 and may be made of a highly-transparent additive. The refractive index of the dopants 20 may be smaller than the refractive index of the body 10 by about 0.001 to about 0.1.

The total refractive index of the BEF 100 is less than the refractive index of the body 10 by about 0.001 to about 0.2. The refractive index of the body 10 without the dopants 20 is about 1.4 to about 1.7 and is preferably about 1.49 to about 1.66.

Thus, the BEF 100 directs or condenses external incident light toward a center portion thereof.

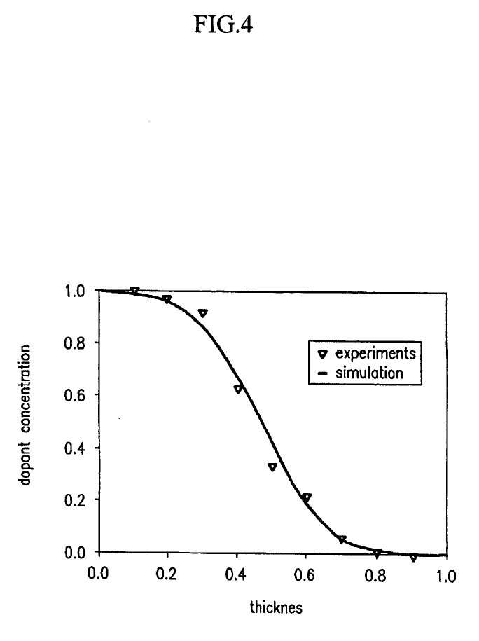

An upper portion of the BEF 100 includes about 20 wt % of dopants 20, a center portion of the BEF 100 includes about 10 wt % of dopants, and a lower portion of the BEF 100 does not include dopants. In addition, an area between the upper portion and the center portion of the BEF 100 includes about 10 wt % to about 20 wt % of the dopants 20, and an area between the center portion and the lower portion of the BEF 100 includes about 0 wt % to about 10 wt % of the dopants 20. The dopant concentration of the BEF 100 gradually varies with respect to a depth of the BEF 100, as represented the graph shown in FIG. 4.

The body 10 of the BEF 100 may be formed of polyethylene terephthalate (PET).

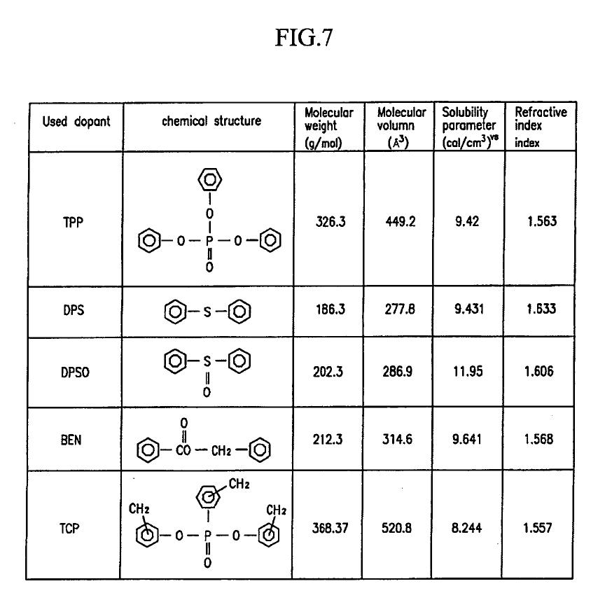

As shown in FIG. 7, the types of typical dopants that may be used in the BEF 100 include triphenyl phosphate (TPP), diphenyl sulfide (DPS), diphenyl sulfoxide (DPSO), benzyl benzoate (BEN), and tricresyl phosphate (TCP). The chemical structure, molecular weight, molecular volume, solubility parameters, and refractive index of the above identified types of dopants are shown in FIG. 7.

The BEF 100 may include either one type of dopant or two or more types of the dopants 20.

The following materials may be used as the dopant 20: diisobutyl adipate, glycerol-triacetate, 2,2,4-trimethyl-1,3-pentanediol diisobutyrate, methyl laurate, dimethyl sebacate, isopropyl myristate, diethyl succinate, diethyl phthalate, tributyl phosphate, dicyclohexyl phthalate, dibutyl sebacate, diisooctyl phthalate, dicapryl phthalate, diisodecyl phthalate, butyl phthalate, octyl phthalate, dicapryl adipate, perfluoro naphthalene, perfluorinated aromatics such as perfluorinated ethers and perfluorinated polyethers, dibenzyl ether, phenoxy toluene, 1,1-bis-(3,4-dimethyl phenyl) ethane, diphenyl ether, biphenyl, diphenyl sulfide, diphenyl methane, benzyl n-butyl-phthalate, 1-methoxyphenyl-1-phenylethane, benzyl benzoate, bromobenzene, o-dichlorobenzene, m-m-dichlorobenzene), 1,2-dibromomethane, 3-phenyl-1-propanol, dioctyl phthalate such as and perfluorinated polyethers.

The following polymers may be included in the BEF 100: polyethylene terephthalate-based compounds or their copolymers, polycarbonate-based compounds or their copolymers, polyvinylidene-based compounds or their copolymers, polyvinyl alcohol-based compounds or their copolymers, polyvinyl acetate-based compounds or their copolymers, sulfonate-based compounds or their copolymers, polymethyl methacrylate-based compounds or their copolymers, polystyrene-based compounds or their copolymers, polyvinyl chloride-based compounds or their copolymers, polynorbonene-based compounds or their copolymers, cycloolefin-based compounds or their copolymers, and their derivatives.

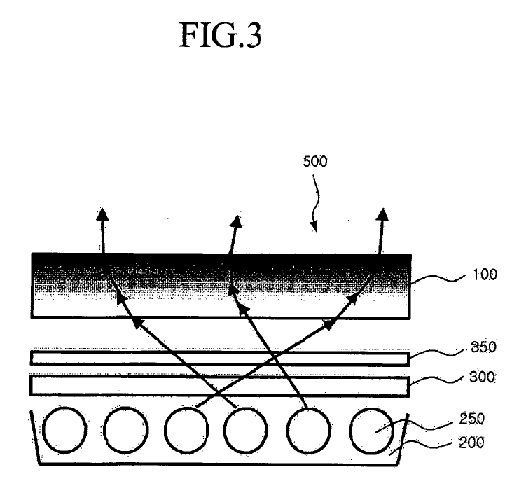

An LCD using the BEF 100 is described below with reference to FIG. 3.

FIG. 3 is a sectional view of an LCD using a BEF according to an embodiment of the invention.

An LCD 500 includes a backlight unit 200 having a plurality of lamps 250, a spread plate 300 disposed on the backlight unit 200, a spread sheet 350 disposed on the spread plate 300, and a BEF 100 disposed on the spread sheet. The BEF 100 may be provided between the backlight unit and a display panel (not shown).

Since the refractive index of dopants 20 at an upper portion of the BEF 100 is less than the refractive index of dopants 20 at a lower portion of the BEF 100, as shown in FIG. 3, as light from the lamps 250 passes through the BEF 100, the light is refracts in a direction that is substantially perpendicular to a surface of the display panel without deviating at sides of the display panel, thereby preventing light loss.

As described above, the dopant concentration of the BEF 100 varies according to a depth of the BEF 100. Characteristics of the BEF 100 according to a variation of the dopant concentration with respect to depth of the BEF are described below with reference to FIGS. 4, 5, and 6.

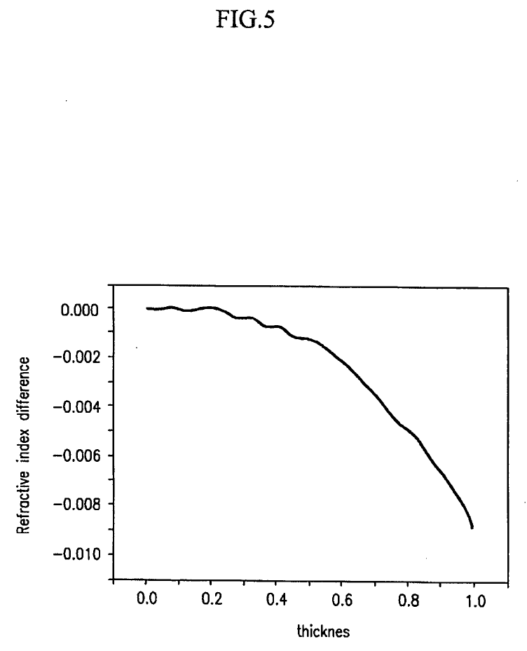

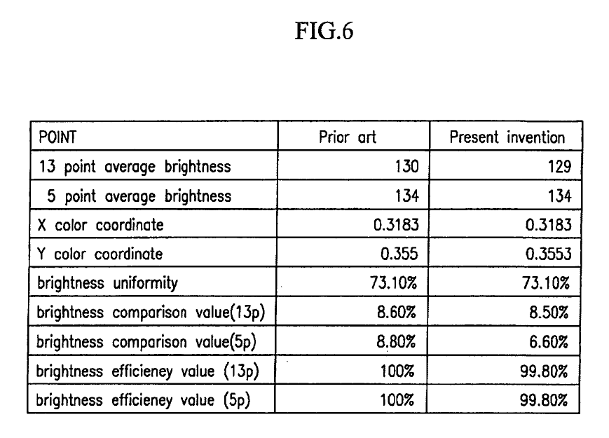

FIG. 4 is a graph showing dopant concentration with respect to a depth of a BEF according to an embodiment of the invention. FIG. 5 is a graph showing refractive index differences with respect to a depth of a BEF according to an embodiment of the invention. FIG. 6 is a table comparing characteristics of a BEF according to an embodiment of the invention with characteristics of a conventional BEF.

FIG. 4 represents a variation of the dopant concentration along a vertical direction of the BEF 100. In FIG. 4, the X-axis represents a normalized thickness of the BEF 100 and the Y-axis represents a normalized dopant concentration of the BEF 100. In the X-axis, “0” refers to an upper surface of the BEF 100 and “1” refers to a lower surface of the BEF 100.

As shown in FIG. 4, the dopant concentration gradually decreases toward the lower surface of the BEF 100.

FIG. 5 represents a variation of the refractive index of the BEF 100 along a vertical direction thereof. In FIG. 5, the X-axis represents a normalized thickness of the BEF 100 and the Y-axis represents a refractive index difference of the BEF 100. The refractive index difference is a difference between the total refractive index “n” of the BEF 100 and a refractive index “n0” at a predetermined position of the BEF 100. Thus, the refractive index difference is “0” at the upper surface of the BEF 100 and is about 0.008 at the lower surface of the BEF 100.

FIG. 6 shows characteristics of the BEF 100 and a conventional BEF.

A conventional BEF is a reflection polarization film that is formed into two layers having different refractive indexes and that are each overlapped with each other multiple times, e.g., hundreds of times or more.

The “point” indicates a number of detection positions detected by a brightness detection device. For example, a 13 point average brightness refers to an average brightness value of thirteen points of an LCD detected by the brightness detection device, and a 5 point average brightness refers to an average brightness value of five points of the LCD detected by the brightness detection device. The uniformity of the brightness is a ratio of the minimum value with respect to the maximum value of the detected brightness values.

The brightness comparison value represents a brightness of light passed through the BEF when a brightness of light from the lamps 250 of the backlight unit 200 is assumed to be “100”. The brightness efficiency represents a brightness of light passed through a BEF according to an embodiment of the invention and a conventional BEF, respectively, as a percentage.

As shown in FIG. 6, characteristics of the BEF according to an embodiment of the invention are different than those of the conventional BEF due to at least the brightness comparison value.

The brightness comparison value of a conventional BEF is larger than that of the present invention. However, the difference of the brightness comparison values may be overcome when the dopant concentration is optimized. As a result, the characteristics of the BEF according to an embodiment of the invention are similar to those of the conventional BEF of the prior art, however the manufacturing cost of the BEF according to an embodiment of the present invention is much less than that of the conventional BEF.

The total dopant concentration of the BEF 100 is about 0.1 wt % to about 50 wt %, and is preferably about 1 wt % to about 35 wt %. The dopant concentration of the BEF 100 is inversely proportional to the thermal characteristics of the BEF 100. As the dopant concentration of the BEF 100 increases a thermal characteristic of the BEF 100 decreases, and on the contrary, as the dopant concentration of the BEF 100 decreases the refractive index distribution does not change.

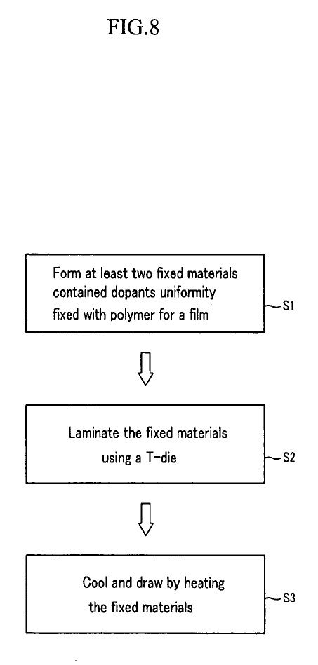

A method of manufacturing a BEF 100 according to an embodiment of the invention is described below with reference to FIGS. 8, 9 and 10.

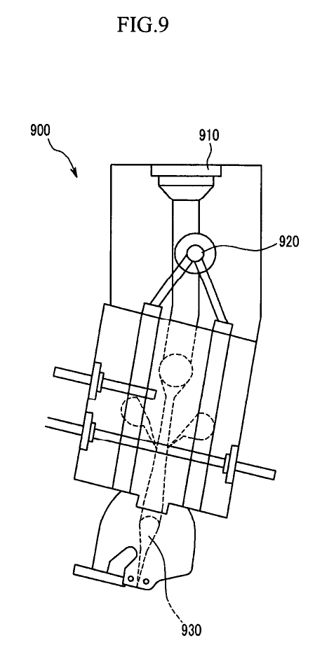

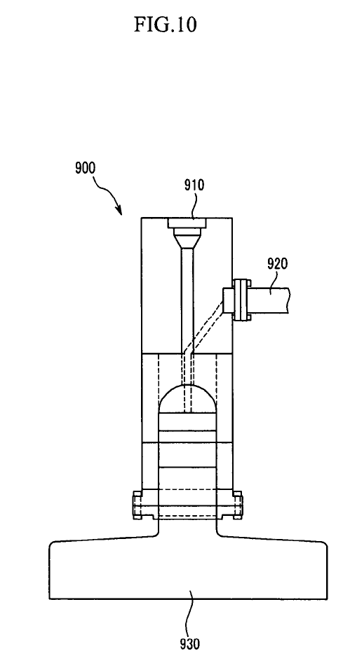

FIG. 8 is a flow chart showing a method of manufacturing a BEF according to an embodiment of the invention. FIG. 9 is a lateral view of a T-die used for manufacturing a BEF according to an embodiment of the invention. FIG. 10 is a front view of the T-die shown in FIG. 9.

As shown in FIG. 8, in operation S1, at least two fixed materials containing dopants substantially uniformly fixed with a polymer for a film are formed. The to be two fixed materials may have dopant concentrations different from each other.

As shown in FIG. 9 and FIG. 10, in operation S2, the fixed materials are injected into respective inlets 910 and 920 of a T-die 900 and laminated in a substantially transverse direction at a space where the inlets 910 and 920 are connected together. The laminated fixed materials are output through an outlet 930. The laminated order of the fixed materials is defined according to the dopant concentration. For example, the fixed material with the lowest dopant concentration is laminated or formed as the lowest layer and the fixed material with the largest dopant concentration is laminated or formed as the uppermost layer.

In operation S3, the laminated fixed materials are then cooled and drawn, e.g., by heating, to complete the BEF with a predetermined thickness, a predetermined width, and predetermined characteristics.

The drawing by heating may be performed using a roller and a thermal treatment device, and may be accomplished twice, e.g., once in a transverse direction and another time in a machinery direction.

For example, during the drawing process, since the laminated fixed materials are in a melted or heated state, the dopants may be moved downwards. Thus, the dopants included in the upper fixed material layer may move into the lower fixed material layer at a boundary area of the layers such that the dopant concentration near the boundary is substantially a middle value between the upper fixed material layer and the lower fixed material layer. As a result, the dopant concentration gradually varies with respect to a depth of the BEF 100.

An upper portion of the BEF 100 includes about 20 wt % of dopants 20, a middle portion of the BEF includes about 10 wt % of dopants and substantially no dopants are included at a lower portion of the BEF.

The laminated fixed materials formed by the manufacturing method may include three fixed materials with about 20 wt %, about 10 wt %, and about 0 wt % of dopants, respectively. The fixed material including about 20 wt % may be laminated as the uppermost layer, the fixed material including about 10 wt % may be laminated as the middle layer, and the fixed material including about 20 wt % may be laminated as the lowest layer.

A BEF may be formed having dopant concentrations that are different from those described above. For example, the lowest layer may include some dopants and/or the number of fixed materials may be changed.

According to at least the above-described embodiments of present invention, the dopant concentration gradually varies with respect to a depth of the BEF. Thus, a manufacturing process of the BEF is made simpler and a manufacturing cost of the BEF decreases. It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents

What is claimed is:

1. A brightness enhancement film (BEF) comprising:
a polymer film comprising dopants,
wherein a concentration of the dopants gradually varies with respect to a depth of the BEF.

2. The BEF of claim 1, wherein a refractive index of the dopants is about 0.001 to about 0.1 less than a refractive index of the polymer.

3. The BEF of claim 1, wherein a refractive index the BEF is about 0.001 to about 0.2 less than a refractive index of a film formed by only the polymer.

4. The BEF of claim 1, wherein the dopants comprise at least two types of dopants.

5. The BEF of claim 1, wherein the dopants are at least one compound selected from the group consisting of diisobutyl adipate, glycerol-triacetate, 2,2,4-trimethyl-1,3-pentanediol diisobutyrate, methyl laurate, dimethyl sebacate, isopropyl myristate, diethyl succinate, diethyl phthalate, tributyl phosphate, dicyclohexyl phthalate, dibutyl sebacate, diisooctyl phthalate, dicapryl phthalate, diisodecyl phthalate, butyl phthalate, octyl phthalate, dicapryl adipate, perfluoro naphthalene, perfluorinated aromatics such as perfluorinated ethers and perfluorinated polyethers, dibenzyl ether, phenoxy toluene, 1,1-bis-(3,4-dimethyl phenyl) ethane, diphenyl ether, biphenyl, diphenyl sulfide, diphenyl methane, benzyl n-butyl-phthalate, 1-methoxyphenyl-1-phenylethane, benzyl benzoate, bromobenzene, o-dichlorobenzene, m-m-dichlorobenzene), 1,2-dibromomethane, 3-phenyl-1-propanol, and dioctyl phthalate.

6. The BEF of claim 1, wherein a polymer of the polymer film is selected from the group consisting of polyethylene terephthalate-based compounds or their copolymer, polycarbonate-based compounds or their copolymer, polyvinylidene-based compounds or their copolymer, polyvinyl alcohol-based compounds or their copolymer, polyvinyl acetate-based compounds or their copolymer, sulfonate-based compounds or their copolymer, polymethyl methacrylate-based compounds or their copolymer, polystyrene-based compounds or their copolymer, polyvinyl chloride-based compounds or their copolymer, polynorbonene-based compounds or their copolymer, cycloolefin-based compounds or their copolymer, and their derivatives.

7. The BEF of claim 1, wherein the dopants have a concentration of about 0.1 wt % to about 50 wt %.

8. The BEF of claim 7, wherein the dopants have a concentration of about 1 wt % to about 35 wt %.

9. A method of manufacturing a brightness enhancement film (BEF), comprising:
forming at least two fixed materials for the BEF which comprise dopants substantially uniformly fixed with a polymer for the BEF and have a different dopant concentration;
sequentially laminating the fixed materials; and
cooling and drawing the laminated fixed materials.

10. The method of claim 9, wherein one of the fixed materials has a dopant concentration of “0.”

11. The method of claim 9, wherein the fixed materials are laminated in an order based on dopant concentration of the fixed materials.

12. The method of claim 11, wherein a fixed material having the smallest dopant concentration laminate is a lowest layer.

13. The method of claim 9, wherein the laminated fixed materials are drawn in both a transverse direction and a machinery direction.

14. The method of claim 9, wherein the dopants included in the fixed material of an upper layer move into the fixed material of a lower layer adjacent to the upper layers when the laminated fixed materials are drawn.
